(19) United States
(12) Patent Application Publication
(10) Pub. No.: US 2024/0405522 A1
(43) Pub. Date: Dec. 5, 2024

(54) SOLUTION PREVENTING PERMANENT DEFORMATION IN AN ARC FAULT EVENT OR SHORT CIRCUIT EVENT

(71) Applicant: Innomotics GmbH, Nürnberg (DE)

(72) Inventor: Bogdan Cristian Ionescu, Carlsbad, CA (US)

(73) Assignee: Innomotics GmbH, Nürnberg (DE)

(21) Appl. No.: 18/697,373

(22) PCT Filed: Nov. 30, 2021
(86) PCT No.: PCT/US2021/061055

§ 371 Date: Mar. 29, 2024

(51) Int. Cl. H02B 1/32

(52) U.S. Cl. CPC H02B 1/32

(57) ABSTRACT

An electric device (100) includes an arc quenching device (140), an arc fault rated cabinet (120) rated to resist an electric arc or short circuit, and an elastic support structure (200) configured to absorb energy based on electrodynamic forces in an arc fault event or a short circuit event. Further, an electric system and a method of calculating elasticity of an elastic beam (200-A, 200-B) configured to absorb energy of electrodynamic forces are described.

### BACKGROUND

### 1. Field

Aspects of the present disclosure generally relate to a solution preventing permanent deformation in an arc fault event or short circuit event, for example in connection with one or multiple electric devices such as for example variable frequency drives, transformers and circuit breakers.

### 2. Description of the Related Art

An electric device, such as for example a variable frequency drive, is typically housed in an enclosure or cabinet. Arc faults may occur within enclosures or cabinets due to for example faulty connections. An internal short circuit may result in an arc fault. Air is ionized between two or more potentials in the electric device by the arc fault, causing an arc flash comprising a plasma cloud of rapidly expanding vaporized metallic materials. The plasma causes high pressures and temperatures to build up quickly, in fractions of a second, within the enclosure. The arc fault conditions must either be contained within the enclosure or vented to the outside of the electric device enclosure.

Arc fault effects are devastating for the equipment where it occurs and secondary effects such as explosive elimination of shrapnel and toxic gases cause serious hazards for personnel. While the electric arc is burning, significant damage of components inside the cabinet occurs in part due to the uncontrolled way the arc is burning. Additionally, the electric arc tends to move inside the cabinet away from the source of energy. This way the damage inside is substantial and as a rule causes permanent damage to the entire cabinet and its contents.

### SUMMARY

Briefly described, aspects of the present disclosure relate to preventing permanent deformation applicable to short circuit withstand or arc fault withstand applications, for example in connection with one or multiple electric devices, in particular electric devices comprising an enclosure, cabinet or housing. For example, the multiple electric devices comprise multiple variable frequency drives. Throughout the specification, the terms “drive”, “drive system”, “multilevel power converter”, “converter”, “power supply” and “variable frequency drive (VFD)” can be used interchangeably.

A first aspect of the present disclosure provides an electric device comprising an arc quenching device, an arc fault rated cabinet rated to resist an electric arc or short circuit, and an elastic support structure configured to absorb energy based on electrodynamic forces in an arc fault event or a short circuit event.

A second aspect of the present disclosure provides an electric system comprising a plurality of electric devices, a common power source, each electric device being electrically coupled to the common power source, wherein at least one electric device comprises an arc quenching device, an arc fault rated cabinet rated to resist an electric arc or short circuit, and an elastic support structure configured to absorb energy based on electrodynamic forces in an arc fault event or a short circuit event.

A third aspect of the present disclosure provides a method of calculating elasticity of an elastic beam configured to absorb energy of electrodynamic forces, the method comprising determining energy of electrodynamic forces based on current and frequency of the current, and calculating a length and cross section of the elastic beam such that the elastic beam absorbs the energy of the electrodynamic forces by elastic deformation.

### BRIEF DESCRIPTION OF THE DRAWINGS

FIG. 1 illustrates a schematic of an electric device with a solution for mitigating an arc fault or short circuit in accordance with an exemplary embodiment of the present disclosure.

FIG. 2 illustrates a schematic of a solution including an elastic support structure for preventing permanent deformation in an arc fault event or short circuit event in connection with an electric device in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being an electric device and an electric system comprising multiple electric devices, specifically a drive system comprising multiple variable frequency drives. Embodiments of the present disclosure, however, are not limited to use in the described methods or system.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

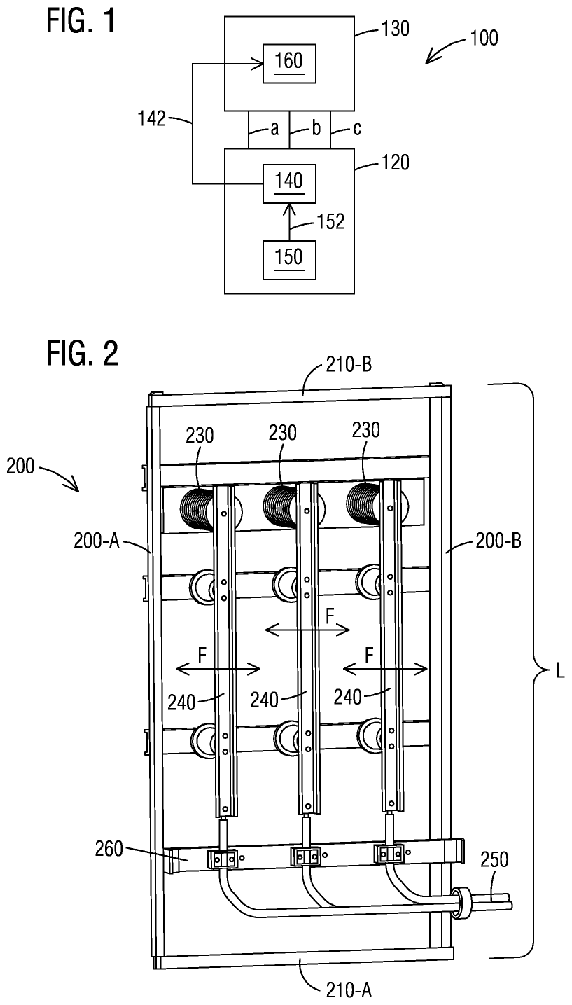

FIG. 1 illustrates a schematic of an electric device 100 with a solution for mitigating an arc fault or short circuit in accordance with an exemplary embodiment of the present disclosure.

The electric device 100 comprises a cabinet or enclosure 120. The cabinet 120 comprises metal and houses electric and/or electronic components. The electric device 100 is for example a variable frequency drive, a transformer, or other type of electric device or system.

The electric device 100 is electrically coupled to a power source 130 for receiving electric power from the power source 130. The power source 130 can be an electric energy source or an electrical substation, such as a transmission substation, of an electrical power transmission and distribution system. The electric power source 130 provides three-phase alternating current (AC) power, illustrated in FIG. 1 by phases a, b, c, wherein the electric device 100 can be configured to output three-phase power to load, such as for example a three-phase AC motor.

As described earlier, electric arcs/arc faults or short circuits may occur within enclosures or cabinets due to for example faulty connections. An internal short circuit may result in an arc fault. In an embodiment, the electric device 100 comprises an arc quenching device 140 and an arc fault rated cabinet 120. In an event of an electric arc (or a short circuit) occurring in the electric device 100, the device 100 is configured to handle and remedy the electric arc because of the arc fault rated cabinet 120 and the arc quenching device 140. Further, the electric device 100 may comprise an arc fault signal interface 150 with an arc sensing circuit configured to monitor characteristics of an electric arc/short circuit within the cabinet 120. Characteristics of an electric arc/short circuit include current, specifically overcurrent, and light, specifically flashlight. Thus, the sensing circuit comprises (over-)current detection and flashlight detection, wherein current and light are continuously monitored by the sensing circuit.

Upon receiving an arc fault signal, the arc fault signal interface 150 activates the arc quenching equipment, specifically the arc quenching device 140 via an electronic signal 152. The arc fault signal interface 150 transmits the signal 152 to the arc quenching device 140. The arc quenching device 140, for example via an arc protection relay, sends a trip signal 142 to a circuit breaker 160 and, at the same time, performs quenching of the arc. The circuit breaker 160 disconnects the power source 130 from the electric device 100.

FIG. 2 illustrates a schematic of a solution including an elastic support structure for preventing permanent deformation in an arc fault event or short circuit event of an electric device in accordance with an exemplary embodiment of the present disclosure. Such an electric device may be configured for example as electric device 100 described with reference to FIG. 1.

It is known that during an arc fault event or a short circuit event, mechanical elements can suffer permanent deformation due to excessive electrodynamic forces caused by high-intensity currents. The described solution prevents permanent deformation of mechanical components during an arc fault event or a short circuit event, by utilizing elasticity of participating mechanical elements.

In an exemplary embodiment of the present disclosure, an electric device, such as electric device 100 (see FIG. 1), comprises an elastic support structure 200 configured to absorb electrodynamic forces by elastic deformation in an arc fault event or a short circuit event. In an example, the elastic support structure 200 is installed in combination with arc quenching device 140 and arc fault rated cabinet 120.

FIG. 2 illustrates components of the arc quenching device 140, including for example switching units 230, bus bars 240 and ground (earth) cables 250. The switching units 230 are controlled, by a controller of the arc quenching device 140, to rapidly close a main current path of the electric device 100 to ground (earth), via bus bars 240 and ground cables 250, thereby creating a lower-impedance current path and transforming an open arc into a controlled 3-phase metallic short circuit. In other words, the arc quenching device 140 converts the electric arc into a bolted short circuit. In an event of an arc fault/short circuit, the bus bars 240 may carry high-intensity currents, such as for example up to 50 kA.

The elastic support structure 200 comprises elastic beams 200-A and 200-B, which are arranged in the cabinet 120, for example in a vertical manner. The elastic support structure 200 further comprises supporting elements 210-A and 210-B. The supporting elements 210-A and 210-B comprise fixed mechanical elements arranged for example in a horizontal manner in the cabinet 120. The supporting elements 210-A and 210-B are essentially non-elastic, fixed mechanical beams mounted within the cabinet 120, comprising for example metal. The elastic beams 200-A and 200-B are securely connected to the supporting elements 210-A and 210-B, for example at ends of the supporting elements 210-A, 210-B, wherein the supporting elements 210-A and 210-B support and hold in place the elastic beams 200-A and 200-B.

The elastic beams 200-A, 200-B are configured according to a specific elasticity, wherein the elastic beams 200-A, 200-B can elastically deform in an arc fault event or short circuit event as designed. In an example, the elasticity is determined via a length L and cross section, for example thickness, of the elastic beams 200-A, 200-B. By varying the length L and cross section of each beam 200-A, 200-B, a specific elasticity can be achieved, for example in accordance with specific electric parameters/requirements of the electric device 100 in an arc fault/short circuit event. After the arc fault/short circuit event, i. e. when the arc fault/short circuit has been successfully mitigated, the elastic beams 200-A, 200-B return to their original shape and/or size.

In an embodiment, the elastic beams 200-A, 200-B are designed to avoid or eliminate a response, specifically a resonant response, to a frequency of short circuit forces. As described earlier, in an arc fault event, the switching units 230 close a main current path of the electric device to ground (earth), via bus bars 240 and ground cables 250, thereby creating a lower-impedance current path and transforming an open arc into a controlled 3-phase metallic short circuit. In an event of an arc fault/short circuit, the bus bars 240 may carry high intensity alternating currents, such as for example up to 50 kA with a frequency of up to 120 Hz. These high intensity current may cause excessive electrodynamic forces, illustrated by arrows F, for example on electric components such as the bus bars 240 etc. To avoid permanent deformation due to electrodynamic forces F, the elastic support structure 200, specifically the elastic beams 200-A, 200-B absorb the forces F such that the elastic beams 200-A, 200-B deform elastically. Thus, the elastic beams 200-A, 200-B are designed, via selection of material, length L and cross section, to avoid or eliminate the resonant response to the frequency of the current, such that the electric components, such as bus bars 240, switches 230 etc. are not damaged and stay intact.

In an example, the elastic beams 200-A, 200-B comprise metal, for example steel. Of course, it should be noted that the elastic beams 200-A, 200-B may comprise other materials suitable for performing the described functionalities, such as plastic materials or other metals.

In another embodiment, the elastic support structure 200 may comprise additional elements to support or assist the elastic beams 200-A, 200-B in an arc fault/short circuit event. Such elements may include one or more springs, such as coil springs or other supporting elastic devices.

In another exemplary embodiment of the present disclosure, the electric device 100 and elastic support structure 200 are part of a larger electric system that comprises multiple electric devices. There is no limitation as to a number of electric devices, such as variable frequency drives, transformers etc., connected within the system, and the system is equipped with an arc fault/short circuit solution for the plurality of electric devices. For example, such a system can be configured so that protection is provided for all the electric devices of the system, wherein only one of the electric devices comprises arc fault/short circuit equipment, e. g. arc quenching device 140 and arc fault rated cabinet 120. Specifically, one of the electric devices is configured as electric device 100 comprising an elastic support structure 200 as described herein. In an event of an electric arc occurring in any of the plurality of electric devices, energy of the arc is transferred to the electric device 100 comprising arc quenching device 140 and arc fault rated cabinet 120 including elastic support structure 200. While arc fault detection is present in each of the electric devices, for example via an arc sensing circuit, only the one electric device 100 with arc fault equipment is required to mitigate the arc fault or short circuit.

In another exemplary embodiment of the present disclosure, a method of calculating elasticity of the elastic beams (200-A, 200-B) is described. The method comprises determining energy of electrodynamic forces based on an alternating current and frequency of the current and calculating a length (L) and cross section of the elastic beam (200-A, 200-B) such that the elastic beam (200-A, 200-B) absorbs the energy of the electrodynamic forces by deformation, in particular elastic deformation. Specifically, the length (L) and cross section of the elastic beams (200-A, 200-B) are calculated such that a resonant response to the frequency of the current in an arc fault event or short circuit event is avoided or eliminated by the elastic beams (200-A, 200-B). Both elastic beams (200-A, 200-B) may comprise the same elasticity, or may comprise different elasticities. In other words, beam (200-A) may be more elastic than the other beam (200-b), depending on for example a configuration of the electric device 100. The elastic beams (200-A, 200-B) comprises steel, and wherein the length (L) and cross section are calculated for elastic steel beams.

In an example, an electric device as described herein, for example the electric device 100, comprises a variable frequency drive, for example medium voltage variable frequency drive and/or low voltage variable frequency drive (medium/low voltages referring to an input voltage of the devices). As used herein, a “medium voltage” is a voltage of greater than about 690V and less than about 69 KV, and a “low voltage” is a voltage less than about 690V. Persons of ordinary skill in the art will understand that other voltage levels may be specified as “medium voltage” and “low voltage”. For example, in some embodiments, a “medium voltage” may be a voltage between about 3 kV and about 69 kV, and a “low voltage” may be a voltage less than about 3 kV.

In an example, the electric device(s) are variable frequency drives comprising a plurality of power cells supplying power to one or more output phases. Medium voltage variable frequency drives, such as for example multilevel power converters, are used in applications of medium voltage alternating current drives, flexible AC transmission systems (FACTS), and High Voltage DC (HVDC) transmission systems, because single power semiconductor devices cannot handle high voltage. Multilevel power converters typically include a plurality of power cells for each phase, each power cell including an inverter circuit having semiconductor switches that can alter the voltage output of the individual cells.

1.-15. (canceled)

16. An electric device comprising:
an arc quenching device,
an arc fault rated cabinet rated to resist an electric arc or short circuit, and
an elastic support structure configured to absorb energy based on electrodynamic forces in an arc fault event or a short circuit event.

17. The electric device of claim 16,
wherein the elastic support structure is configured to absorb the energy of electrodynamic forces by elastic deformation.

18. The electric device of claim 16,
wherein the elastic support structure comprises elastic beams arranged in the arc fault rated cabinet, wherein the elastic beams are configured to elastically deform when absorbing the energy.

19. The electric device of claim 16,
wherein the elastic support structure comprises supporting elements including fixed mechanical elements arranged in the arc fault rated cabinet, and wherein the elastic beams are securely connected at ends of the fixed mechanical elements.

20. The electric device of claim 19,
wherein the elastic beams each comprise a specific elasticity, wherein the specific elasticity is defined by a length and a cross section of the elastic beams.

21. The electric device of claim 20,
wherein the elastic beams are each configured to avoid or eliminate a resonant response to a frequency of an alternating current in the arc fault event or short circuit event.

22. The electric device of claim 18,
wherein the elastic beams comprise steel.

23. The electric device of claim 16,
further comprising one or more springs to assist the elastic support structure in response to the arc fault or short circuit.

24. The electric device of claim 16,
wherein the arc quenching device comprises switching units coupled via bus bars to ground cables, and wherein, in the arc fault event or short circuit event, the bus bars carry alternating currents that cause the electrodynamic forces.

25. An electric system comprising:
a plurality of electric devices,
a common power source, each electric device being electrically coupled to the common power source,
wherein at least one electric device comprises
an arc quenching device,
an arc fault rated cabinet rated to resist an electric arc or short circuit, and
an elastic support structure configured to absorb energy based on electrodynamic forces in an arc fault event or a short circuit event.

26. The electric system of claim 25,
wherein, in an event of an electric arc occurring in any of the plurality of electric devices, energy of the electric arc is transferred to the at least one electric device and the arc quenching device activated.

27. The electric system of claim 25, further comprising:
a circuit breaker configured to disconnect the common power source from the plurality of electric devices, wherein the circuit breaker is activated by the arc quenching device in response to an arc fault signal.

28. A method of calculating elasticity of an elastic beam configured to absorb energy of electrodynamic forces, the method comprising:
determining energy of electrodynamic forces based on current and frequency of the current, and
calculating a length and cross section of the elastic beam such that the elastic beam absorbs the energy of the electrodynamic forces by elastic deformation.

29. The method of claim 28,
wherein the length and cross section of the elastic beam are calculated such that a resonant response to the frequency of the current in an arc fault event or short circuit event by the elastic beam is avoided or eliminated.

30. The method of claim 28,
wherein the elastic beam comprises steel, and wherein the length and cross section are calculated for elastic steel beams.
